(19) United States
(12) Patent Application Publication
(10) Pub. No.: US 2013/0250182 A1
(43) Pub. Date: Sep. 26, 2013

(54) METHOD, DEVICE AND SYSTEM FOR MOBILE TERMINAL TO CONTROL DIGITAL TELEVISION RECEIVING TERMINAL

(71) Applicants: Ming Yuan, Shenzhen (CN); Yanbo Shen, Shenzhen (CN)

(72) Inventors: Ming Yuan, Shenzhen (CN); Yanbo Shen, Shenzhen (CN)

(21) Appl. No.: 13/994,075

(22) PCT Filed: Mar. 25, 2011
(86) PCT No.: PCT/CN2011/072156

§ 371 Date: Jun. 13, 2013

(30) Foreign Application Priority Data
Dec. 15, 2010 (CN) 201010590023.4

(51) Int. Cl. H04N 5/44

(52) U.S. Cl. CPC H04N 5/4403
USPC 348/734

(57) ABSTRACT

A method for a mobile terminal to control a digital television receiving terminal includes that: the mobile terminal provides a first remote control interface; the mobile terminal sends a selection instruction to the digital television receiving terminal, wherein the selection instruction instructs the service which a user selects on the first remote control interface; and the mobile terminal switches to a second remote control interface corresponding to the service which the user selects on the first remote control interface. A terminal includes a sending module for sending the selection instruction to the digital television receiving terminal, wherein the selection instruction instruct the service which the user selects on the first remote control interface; and a switching module for switching to the second remote control interface corresponding to the service which the user selects on the first remote control interface.

### CROSS REFERENCE TO RELATED APPLICATIONS

This application claims the benefit of priority to China patent application No. 201010590023.4 filed with the Chinese Patent Office on Dec. 15, 2010 and entitled “METHOD, DEVICE AND SYSTEM FOR MOBILE TERMINAL TO CONTROL DIGITAL TELEVISION RECEIVING TERMINAL”, the contents of which are incorporated herein by reference in their entirety.

### FIELD OF THE INVENTION

The present invention relates to mobile terminal technical field, more particularly, to a method, device and system for mobile terminal to control digital television receiving terminal.

### BACKGROUND OF THE INVENTION

With the popularity of digital television, Set-Top Boxes are used by every family gradually. With the services provided by photo-electric operators becoming increasingly diverse, the more services become available for the users, and at the same time, the operation becomes more complex. However, with functions of a smart mobile phone are constantly growing, the mobile phone used as the remote control of a Set-Top Boxes or a digital television is more applied remote control.

In the art, when a mobile phone is used as the remote control of a Set-Top Boxes or digital television, the function of a remote control is realized only by fixed keys or a special remote control interface on a touch screen of the mobile phone.

In the particular embodiment, because the digital television operators provide a variety of services, there are special key areas corresponding to the service on the remote control to be operated., However, when a mobile phone is used as the remote control, due to the limitation of the quantity of keys or an area of the touch screen of the mobile phone, either the remote control function cannot be completely realized, or the keys are too small to be convenient for the user to operate.

### SUMMARY OF THE INVENTION

The technical problem to be solved by the present invention is: to provide a method, device and system for mobile terminal to control digital television receiving terminal, to provide different remote control interfaces according to different service application in the digital television receiving terminal, to facilitate the user.

To solve the technical problem of the present invention, the present invention provides a method for mobile terminal to control digital television receiving terminal. The method includes:

a mobile terminal provides a first remote control interface;

the mobile terminal transmits a selection instruction to a digital television receiving terminal, wherein the selection instruction instructs the service which a user selects on the first remote control interface selection;

the mobile terminal switches to a second remote control interface corresponding to the service which a user selects on the first remote control interface.

To solve the technical problem of the present invention, the present invention provides a mobile terminal. The mobile terminal includes:

a transmitting module configured to transmit a selection instruction to a digital television receiving terminal, wherein the selection instruction instructs the service which a user selects on the first remote control interface selection;

a switching module configured to switch to a second remote control interface corresponding to the service which a user selects on the first remote control interface.

To solve the technical problem of the present invention, the present invention provides a digital television receiving terminal. The digital television receiving terminal includes:

a receiving module configured to receive a selection instruction;

a processing module configured to enter into an operating mode of the service corresponding to the selection instruction;

a transmitting module configured to return a respond message according to the selection instruction.

To solve the technical problem of the present invention, the present invention provides a system for mobile terminal to control digital television receiving terminal. The system includes: the above-mentioned mobile terminal and digital television receiving terminal.

Compared with the art, the present invention has the following beneficial effects: when a mobile terminal is used as a remote control in the present invention, a remote control interface, corresponding to the different service applications of the digital television receiving terminal, is switched, to facilitate the users.

### BRIEF DESCRIPTION OF THE DRAWINGS

FIG. 1 is a flowchart of a method for mobile terminal to control digital television receiving terminal according to one embodiment of the present invention;

FIG. 2 is a flowchart of a method for mobile terminal to control digital television receiving terminal according to another embodiment of the present invention;

FIG. 3 is a structure diagram of a mobile terminal according to one embodiment of the present invention;

FIG. 4 is a structure diagram of a digital television receiving terminal according to one embodiment of the present invention;

FIG. 5 is a structure diagram of a system for mobile terminal to control digital television receiving terminal according to one embodiment of the present invention.

### DETAILED DESCRIPTION OF ILLUSTRATED EMBODIMENTS

The embodiments of the present invention provide a method, device and system for mobile terminal to control digital television receiving terminal, different remote control interfaces are provided according to different service application in the digital television receiving terminal, to facilitate the users.

Further description of the present invention will be illustrated, which combined with embodiments and drawings, in order to make the technical schemes clearer and completely. Obviously, the embodiments described herein are only a part of embodiments, but not all of embodiments. Based on the embodiments of the present invention, all of other embodiments obtained by the person skilled in the art who have not do any creative labor should be fallen within the protection scope of the present invention.

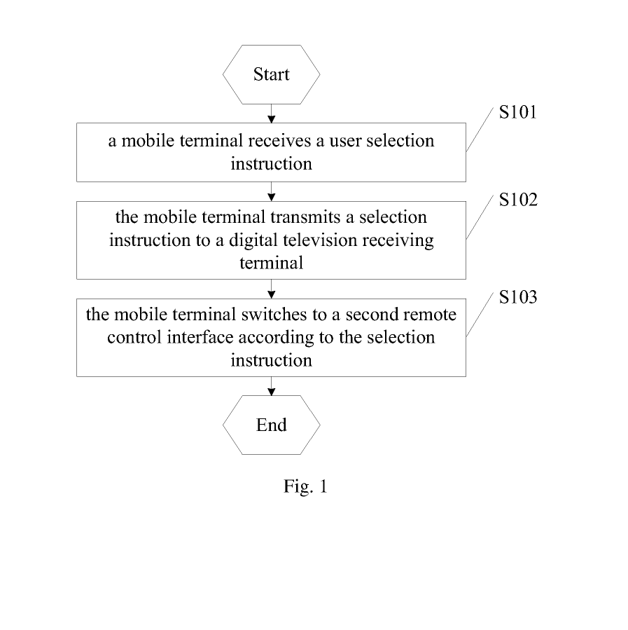

Referring to FIG. 1, FIG. 1 is a flowchart of a method for mobile terminal to control digital television receiving terminal according to one embodiment of the present invention;

The remote control of the current digital television receiving terminal is generally divided into several control areas, which correspond to different functions or service applications.

For example, direction key is used to adjust the volume and change the channels. The number keys 0-9 denote the channels 0-9. One of the number keys 0-9 is pressed, the channel corresponding to the pressed number key is shown directly. Therefore, it is convenient for users to control the play of program video when users require a program on-demand and operate the function setting areas of a digital television receiving terminal etc. through operating a single key

The embodiment of the present invention aims to solve the problem: when a mobile phone is used as a remote control of digital television receiving terminal, the functions of keys of the mobile phone are less, or considering that the keys of the mobile phone simulate all of the keys of the remote control, and the sizes of screen of the mobile phone is limited, the keys are too small. So that it is inconvenient for user to use. The main idea of the embodiment of the present invention is to provide the remote control interfaces corresponding to different service demands of digital television receiving terminal to facilitate the user. Particularly referring to the following steps:

Step S101, a mobile terminal receives a user selection instruction;

When the mobile terminal switches to remote control operation mode, a default remote control interface is provided for the user according to a preset rule. The interface may be a simple interface which includes direction keys and a confirmation key.

A service of a digital television receiving terminal is selected by the user through the direction keys and confirmation key.

Step S102, the mobile terminal transmits a selection instruction to a digital television receiving terminal. The selection instruction instructs the service which a user selects on the default remote control interface is instructed. The default remote control interface is a first remote control interface;

After the user selected the service, the mobile terminal transmits the selection instruction corresponding to the service to the digital television receiving terminal. In particular, the mobile terminal can transmit the selection instruction to the digital television receiving terminal via Blue Tooth and/or Wireless Fidelity (wifi).

Step S103, the mobile terminal switches to a second remote control interface according to the selection instruction.

After the mobile terminal transmits the selection instruction, the mobile terminal switches automatically to a second remote control interface corresponding to the service corresponding to the selection instructions. Wherein the service corresponding to the selection instructions is a service which a user selects on the default remote control interface.

In the embodiment of the present invention, when the mobile terminal is used as the remote control, the mobile terminal can switch to remote control interfaces corresponding to the different service of the digital television receiving terminal, which facilitate the user.

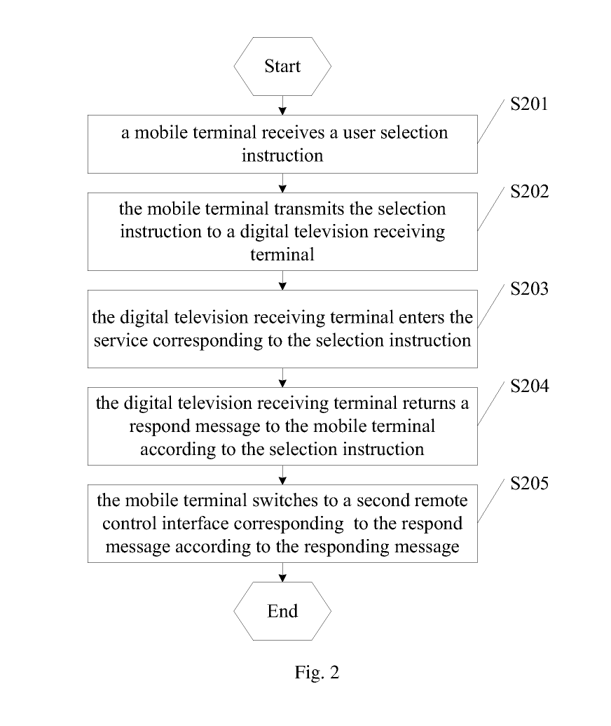

Referring to FIG. 2, FIG. 2 is a flowchart of a method for mobile terminal to control digital television receiving terminal according to another embodiment of the present invention;

Based on the embodiment corresponding to FIG. 1, the embodiment of the present invention is provided to avoid conditions that the selection instruction is not received by the digital television receiving terminal or the digital television receiving terminal is not switched to the service corresponding to the selection instruction normally after the selection instruction is transmitted, while the mobile terminal switches to the remote control interface, which leads to use inconveniently.

Step S201, a mobile terminal receives a user selection instruction;

When the mobile terminal switches to a remote control operation mode, a default remote control interface is provided for the user according to a preset rule, the interface may be a simple interface which includes direction keys and a confirmation key.

A user selects a service of a digital television receiving terminal through the direction keys and confirmation key.

Step S202, the mobile terminal transmits the selection instruction to a digital television receiving terminal;

After the user selected the service, the mobile terminal transmits the selection instruction corresponding to the service to the digital television receiving terminal. In particular, the mobile terminal can transmit the selection instruction to the digital television receiving terminal via Blue Tooth and/or Wireless Fidelity (wifi).

Step S203, the digital television receiving terminal enters the service corresponding to the selection instruction;

After the digital television receiving terminal receives the selection instruction, the digital television receiving terminal enters the operation mode of the service corresponding to the selection instruction. Wherein, the service corresponding to the selection instructions is a service which a user selects on the default remote control interface.

Step 204, the digital television receiving terminal returns a respond message to the mobile terminal according to the selection instruction;

After the digital television receiving terminal receives the selection instruction, the digital television receiving terminal returns the respond message to the mobile terminal according to the selection instruction. In particular, the respond message is transmitted via Blue Tooth and/or wifi. Wherein after the digital television receiving terminal enters the operation mode of the service corresponding to the selection instruction, the digital television receiving terminal returns the respond message to the mobile terminal. The respond message denotes that the digital television receiving terminal has entered the operation mode of the service corresponding to the selection instruction.

Step S205, the mobile terminal switches to a second remote control interface corresponding to the respond message according to the responding message.

Now, after the mobile phone receives the respond message, which returned by the digital television receiving terminal after finishing switching, the mobile phone switches to the remote control interface. Therefore, the remote control interface is ensured to correspond to the service application, which facilitates the user.

In the embodiment of the present invention, when the program corresponding to the user selection instruction is a program on-demand in the step S201, in the step S204, the digital television receiving terminal returns the respond message to the mobile terminal after the program on-demand is obtained normally. In the step S205, the mobile terminal switches the operation interface to the remote control interface corresponding to the program on-demand. For example, the remote interface may include fast-forwarding key, fast-retreating key, pausing key, stopping key, and starting key etc. However, the above-mentioned keys may be not needed by the service before switched, the remote interface may only include direction key, confirmation key, and returning key etc.

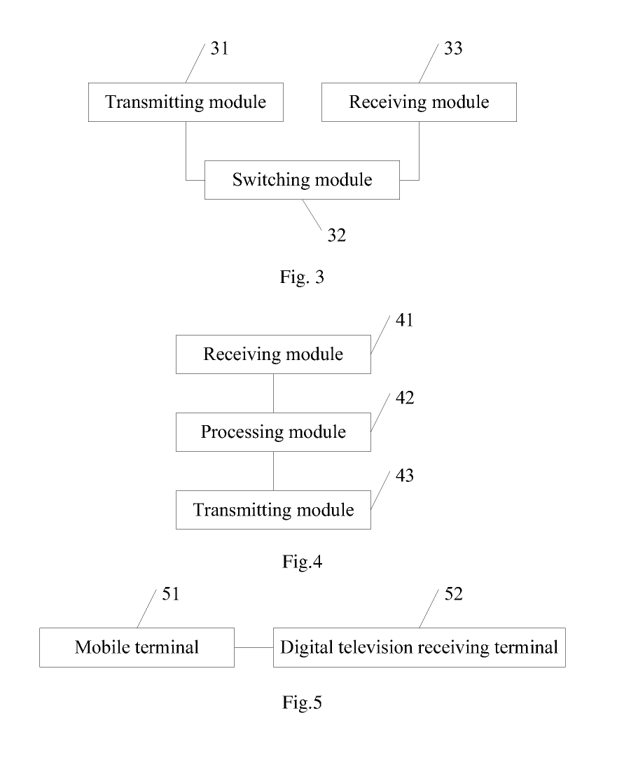

Referring to FIG. 3, FIG. 3 is a structure diagram of a mobile terminal according to one embodiment of the present invention;

The embodiment of the present invention provides a mobile terminal corresponding to the above-mentioned method embodiment; the mobile terminal includes:

a transmitting module 31, which is configured to transmit a selection instruction to a digital television receiving terminal. The selection instruction instructs the service which a user selects on the first remote control interface;

a switching module 32, which is configured to switch to a second remote control interface corresponding to the service which a user selects on the first remote control interface.

The mobile terminal further includes:

a receiving module 33, which is configured to receive a respond message returned by the digital television receiving terminal according to the selection instruction;

the switching module 32 is particularly configured to switch to the second remote control interface according to the respond message.

Further, the transmitting module 31 is particularly configured to transmit the selection instruction via Blue Tooth and/or wifi to a digital television receiving terminal according the user selection when the mobile terminal is in the first remote control interface.

In particular, the two way can be used for the mobile terminal to switch to remote control interface in the embodiment of the present invention: the first way, after the transmitting module 31 transmitted the selection instruction, the switching module 32 is switched automatically to the second remote control interface. But it is not convenient to use because the selection instruction is not received by the digital television receiving terminal or the digital television receiving terminal is not switched to corresponding service normally after the selection instruction is transmitted, and the mobile terminal is switched to remote control interface. So a receiving module 33 is provided for the mobile terminal in the embodiment of the present invention, until the respond message ,which is returned by the digital television receiving terminal after it has been switched, is received by the receiving module 33, the switching module 32 switches to the remote control interface.

Referring to FIG. 4, FIG. 4 is a structure diagram of a digital television receiving terminal according to one embodiment of the present invention;

The embodiment of the present invention provides a digital television receiving terminal, the digital television receiving terminal includes:

a receiving module 41, which is configured to receive a selection instruction;

a processing module 42, which is configured to enter an operating mode of the service corresponding to the selection instruction;

a transmitting module 43, which is configured to return a respond message according to the selection instruction.

Further, the transmitting module 43 is particularly configured to return the respond message via Blue Tooth and/or wifi.

In the embodiment of the present invention, the respond message can be returned by the transmitting module 43 after the processing module 42 entered the operating mode of the service corresponding to the selection instruction.

When the program corresponding to the user selection instruction is a program on-demand, the mobile terminal returns the respond message after the processing module 42 obtained the program on-demand.

Referring to FIG. 5, FIG. 5 is a structure diagram of a system for mobile terminal to control digital television receiving terminal according to one embodiment of the present invention.

The embodiment of the present invention provides a system for mobile terminal to control digital television receiving terminal, the system includes:

a mobile terminal 51, which is configured to transmit a selection instruction to a digital television receiving terminal 52 according to the user selection when it is in a first remote control interface, and switch to a second remote control interface corresponding to a corresponding service of the selection instruction;

a digital television receiving terminal 52, which is configured to receive the selection instruction and entered the service corresponding to the selection instruction.

In particular, in the embodiment of the present invention, the mobile terminal 51 may be the mobile terminal provided in the embodiment as shown in FIG. 3; the digital television receiving terminal may be the digital television receiving terminal provided in the embodiment as shown in FIG. 4.

The digital television receiving terminal of the present invention includes but is not limited to be: the terminal having the function of receiving digital television, such as Set-Top Box, Internet Protocol Television (IPTV), digital television integrated machine and television mobile phone. The mobile terminal of the present invention includes but is not limited to be: mobile phone, panel computer, Personal Digital Assistant (PDA) and Mobile Internet Device (MID) etc.

The preferred embodiments described above further illustrate specifically the purpose, technical schemes and advantages of the present invention, it should be understood that what are said above are only preferred embodiments of present invention, not intended to limit the present invention, any modifications, equivalent substitutions and improvements etc. made within the spirit and principle of the present invention, should be included in the protection range of the present invention, the right ranges of the present invention claimed for should be based on the ranges of the invention claimed for, not only be limited to the above embodiments.

1. A method for mobile terminal to control digital television receiving terminal, comprising:
a mobile terminal providing a first remote control interface;
the mobile terminal transmitting a selection instruction to a digital television receiving terminal, wherein, the selection instruction instructs the service which a user selects on the first remote control interface;
the mobile terminal switching to a second remote control interface corresponding to the service which a user selects on the first remote control interface.

2. The method of claim 1, after the mobile terminal transmitting a selection instruction to a digital television receiving terminal, the method further comprising:
the digital television receiving terminal receiving the selection instruction, and entering an operating mode of the service corresponding to the selection instruction; wherein, the selection instruction instructing the service which a user selects on the first remote control interface.

3. The method of claim 2, after the digital television receiving terminal receiving the selection instruction , the method further comprising:
the digital television receiving terminal transmitting corresponding respond message to the mobile terminal according to the selection instruction.

4. The method of claim 3, the mobile terminal switching to a second remote control interface corresponding to the service which a user selects on the first remote control interface, comprising:
according to the respond message, the mobile terminal switching to the second remote control interface corresponding to the service which a user selects on the first remote control interface.

5. The method of any of claim 1, the mobile terminal transmitting a selection instruction to a digital television receiving terminal, comprising:
the mobile terminal transmitting the selection instruction via Blue Tooth and/or Wireless Fidelity to a digital television receiving terminal.

6. A mobile terminal, comprising:
transmitting module, which is configured to transmit a selection instruction to a digital television receiving terminal, wherein the selection instruction instructs the service which a user selects on the first remote control interface;
switching module, which is configured to switch to a second remote control interface corresponding to the service which a user selects on the first remote control interface.

7. The mobile terminal of claim 6, the mobile terminal further comprising:
receiving module, which is configured to receive a respond message returned by the digital television receiving terminal according to the selection instruction;
switching module, which is particularly configured to switch to a second remote control interface corresponding to the service which a user selects on the first remote control interface according to the respond message.

8. The mobile terminal of claim 7, the transmitting module is particularly configured to transmit the selection instruction via Blue Tooth and/or Wireless Fidelity to a digital television receiving terminal.

9. A digital television receiving terminal, comprising:
receiving module, which is configured to receive a selection instruction;
processing module, which is configured to enter an operating mode of the service corresponding to the selection instruction;
transmitting module, which is configured to return a respond message according to the selection instruction.

10. The digital television receiving terminal of claim 9, the transmitting module is particularly configured to return the respond message via Blue Tooth and/or Wireless Fidelity.

11. (canceled)

12. The method of any of claim 2, the mobile terminal transmitting a selection instruction to a digital television receiving terminal, comprising:
the mobile terminal transmitting the selection instruction via Blue Tooth and/or Wireless Fidelity to a digital television receiving terminal.

13. The method of any of claim 3, the mobile terminal transmitting a selection instruction to a digital television receiving terminal, comprising:
the mobile terminal transmitting the selection instruction via Blue Tooth and/or Wireless Fidelity to a digital television receiving terminal.

14. The method of any of claim 4, the mobile terminal transmitting a selection instruction to a digital television receiving terminal, comprising:
the mobile terminal transmitting the selection instruction via Blue Tooth and/or Wireless Fidelity to a digital television receiving terminal.
